(19) United States
(12) Patent Application Publication
(10) Pub. No.: US 2019/0162161 A1
(43) Pub. Date: May 30, 2019

(54) WAVE ENERGY ISOLATION DEVICE AND WAVE ENERGY CONVERSION EQUIPMENT USING THE SAME

(71) Applicant: INDUSTRIAL TECHNOLOGY RESEARCH INSTITUTE, Hsinchu (TW)

(72) Inventors: Shih-Ying CHIANG, Shoufeng Township (TW); Shih-Sheng HSU, Toufen City (TW)

(21) Appl. No.: 15/949,947

(22) Filed: Apr. 10, 2018

(30) Foreign Application Priority Data
Nov. 29, 2017 (TW) 106141529

(51) Int. Cl. F03B 13/20; F15B 1/02; F03B 13/10; F04B 17/00; F04B 49/12

(52) U.S. Cl. CPC F03B 13/20; F15B 1/024; F04B 49/125; F04B 17/00; F03B 13/10

(57) ABSTRACT

A wave energy isolation device includes a fixed displacement hydraulic motor and a variable displacement hydraulic pump. The variable displacement hydraulic pump outputs a working fluid to the fixed displacement hydraulic motor. The variable displacement hydraulic pump changes an output displacement of the working fluid according to a control parameter.

This application claims the benefit of Taiwan application Serial No. 106141529, filed Nov. 29, 2017, the disclosure of which is incorporated by reference herein in its entirety.

### TECHNICAL FIELD

The disclosure relates in general to a wave energy isolation device and a wave energy conversion equipment using the same, and more particularly to a wave energy isolation device equipped with a variable displacement hydraulic pump and a wave energy conversion equipment using the same.

### BACKGROUND

The wave energy conversion equipment can convert a wave energy of the wave into an electrical energy. However, when the weather is adverse, gigantic waves may generate a large volume of wave energy which may make the power generator of the wave energy conversion equipment overloaded and damaged. Therefore, how to provide a wave energy conversion equipment capable of resolving the generally known problems disclosed above has become a prominent task for the industries.

### SUMMARY

According to one embodiment, a wave energy isolation device is provided. The wave energy isolation device includes a fixed displacement hydraulic motor and a variable displacement hydraulic pump. The variable displacement hydraulic pump outputs a working fluid to the fixed displacement hydraulic motor. The variable displacement hydraulic pump changes an output displacement of the working fluid according to a control parameter.

According to another embodiment, a wave energy conversion equipment is provided. The wave energy conversion equipment includes a wave energy isolation device, a winch and a power generator. The wave energy isolation device includes a fixed displacement hydraulic motor and a variable displacement hydraulic pump. The variable displacement hydraulic pump outputs a working fluid to the fixed displacement hydraulic motor. The variable displacement hydraulic pump changes an output displacement of the working fluid according to a control parameter. The winch is connected to the variable displacement hydraulic pump for providing an input shaft power to drive the variable displacement hydraulic pump. The power generator is connected to the fixed displacement hydraulic motor. The fixed displacement hydraulic motor is driven by the working fluid to provide an output shaft power to the power generator.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1A is a schematic diagram of a wave energy conversion equipment according to an embodiment of the disclosure.

FIG. 1B is a function block diagram of the wave energy isolation device of FIG. 1A.

FIG. 2 is a relationship diagram of the internal pressure of the wave energy isolation device of FIG. 1B vs the output power of a power generator.

FIG. 3A is a function block diagram of a wave energy isolation device according to another embodiment of the disclosure.

FIG. 3B is a relationship diagram of the internal pressure of the wave energy isolation device of FIG. 3A vs the output power of a power generator.

FIG. 4 is a function block diagram of a wave energy isolation device according to another embodiment of the disclosure.

FIG. 5 is a function block diagram of a wave energy isolation device according to another embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The disclosure is directed to a wave energy isolation device and a wave energy conversion equipment using the same capable of resolving the generally known problems disclosed above.

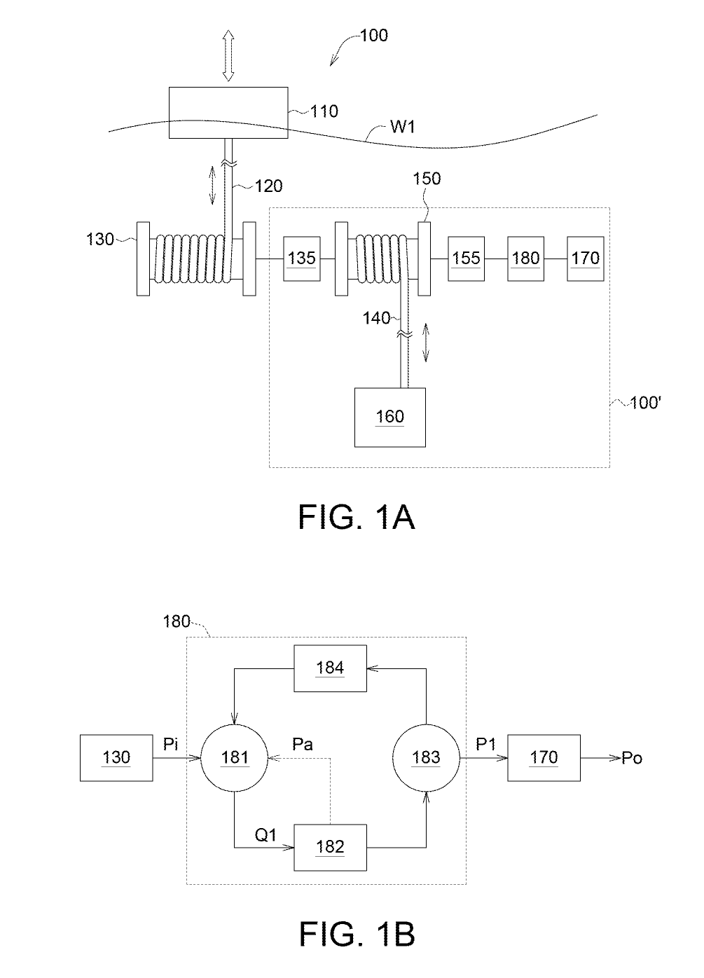

Refer to FIGS. 1A and 1B. FIG. 1A is a schematic diagram of a wave energy conversion equipment 100 according to an embodiment of the disclosure. FIG. 1B is a function block diagram of the wave energy isolation device 180 of FIG. 1A.

As indicated in FIGS. 1A and 1B, the wave energy conversion equipment 100 includes a floater 110, a first cable 120, a first winch 130, a speed reducer 135, a second cable 140, a second winch 150, a speed increaser 155, a ballast weight 160, a power generator 170 and a wave energy isolation device 180. The floater 110 floats on the sea surface W1 and fluctuates with the sea surface W1. The first cable 120 connects the floater 110 to the first winch 130. The second winch 150 is connected the first winch 130. When the floater 110 fluctuates with the sea surface W1, the first cable 120 drives the first winch 130 to rotate and the first winch 130 accordingly drives the second winch 150 to rotate and provide an input shaft power Pi to the wave energy isolation device 180. Then, the wave energy isolation device 180 converts the input shaft power Pi into an output shaft power P1 and further provides the output shaft power P1 to the power generator 170 and makes the power generator 170 generate electricity.

The second cable 140 connects the ballast weight 160 to the second winch 150. When the first cable 120 becomes loose (for example, when the floater 110 is at the valley of the wave), the ballast weight 160 can pull down the second winch 150 to rotate and drive the first winch 130 to rotate and pull the first cable 120 tightly. Thus, when the floater 110 is pushed to the crest of the wave by the sea surface W1, the first cable 120 can pull the first winch 130 to rotate.

As indicated in FIG. 1A, the speed reducer 135 connects the first winch 130 to the second winch 150 to reduce rotation speed of the second winch 150. Thus, even when the floater 110 is thrown off the sea surface and then free falls, the first cable 120 is still pulled tightly. The speed increaser 155 connects the second winch 150 to the wave energy isolation device 180 to increase the rotation speed of the second winch 150, such that the rotation speed of the power generator 170 remains at an expected efficiency.

The speed reducer 135, the second cable 140, the second winch 150, the speed increaser 155, the ballast weight 160, the power generator 170 and the wave energy isolation device 180 of FIG. 1A can be configured in a casing to avoid these elements being eroded by sea water. The casing and these elements together form a wave power generator 100′.

The wave energy isolation device 180 can control the output shaft power P1 outputted to the power generator 170 to be under an upper limit to avoid the power generator 170 being damaged by an overvoltage of the output shaft power P1. Thus, even when the power generator 170 is exposed to irresistible factors such as typhoons or cyclones, the power generator 170 will not be overloaded and damaged.

As indicated in FIG. 1B, the wave energy isolation device 180 includes a variable displacement hydraulic pump 181, an accumulator 182, a fixed displacement hydraulic motor 183 and a fluid container 184. The variable displacement hydraulic pump 181, the accumulator 182, the fixed displacement hydraulic motor 183 and the fluid container 184 form a closed loop, such that the working fluid F1 (not illustrated) flows through the variable displacement hydraulic pump 181, the accumulator 182, the fixed displacement hydraulic motor 183 and the fluid container 184 in sequence and circulates incessantly. That is, the variable displacement hydraulic pump 181 outputs the working fluid F1 to the fixed displacement hydraulic motor 183 through the accumulator 182. Besides, the fluid container 184 receives the working fluid F1 discharged from the fixed displacement hydraulic motor 183, and provides the working fluid F1 to the variable displacement hydraulic pump 181, which further outputs the working fluid F1.

The variable displacement hydraulic pump 181 changes an output displacement Q1 of the working fluid F1 according to a control parameter.

In an embodiment, the working fluid F1 can be realized by oil, but the disclosure is not limited thereto.

To put it in greater details, the variable displacement hydraulic pump 181, being driven by the input shaft power Pi of the first winch 130, sucks the working fluid F1 of the fluid container 184. Then, the variable displacement hydraulic pump 181 pressurizes the working fluid F1 and provides it to the accumulator 182. Then, the working fluid F1 outputted from the accumulator 182 is inputted to the fixed displacement hydraulic motor 183. The pressurized working fluid F1 drives the fixed displacement hydraulic motor 183 to operate and convert a hydraulic potential energy of the working fluid F1 which is pressurized into a mechanical shaft power to provide an output shaft power P1 to the power generator 170. The working fluid F1 is depressurized by the fixed displacement hydraulic motor 183, and reflows to the fluid container 184. Then, the working fluid F1 flows through the variable displacement hydraulic pump 181, the accumulator 182, the fixed displacement hydraulic motor 183 and the fluid container 184 in sequence and circulates incessantly.

As indicated in FIG. 1B, the variable displacement hydraulic pump 181 outputs a working fluid F1 to the fixed displacement hydraulic motor 183 through the accumulator 182, wherein the variable displacement hydraulic pump 181 controls the output displacement Q1 of the working fluid F1 according to an internal pressure Pₐ of the accumulator 182. In an embodiment, the variable displacement hydraulic pump 181 can be realized by a swash-plate type plunger pump.

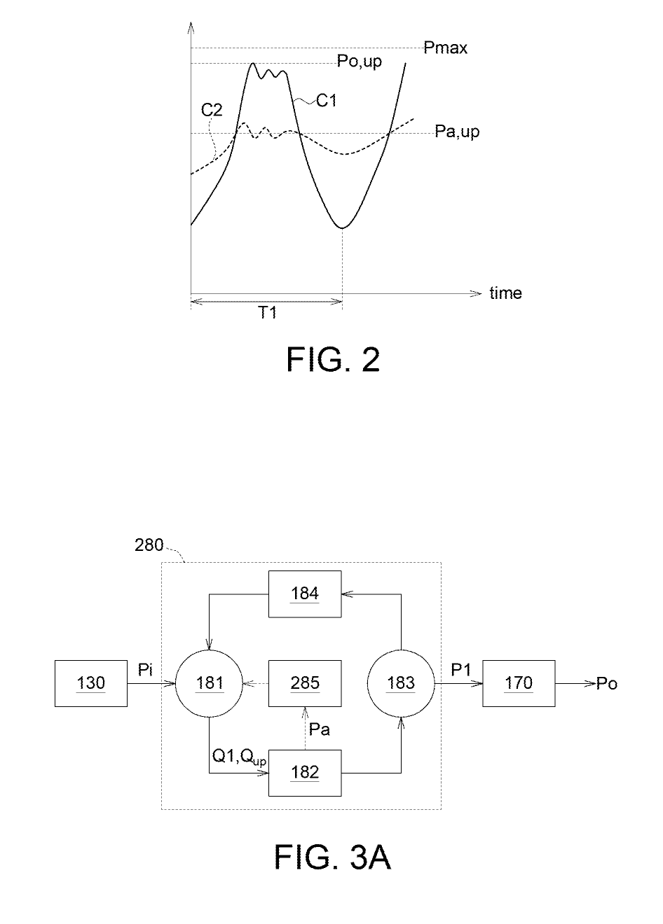

Refer to FIGS. 1B and 2. FIG. 2 is a relationship diagram of the internal pressure Pₐ of the wave energy isolation device 180 of FIG. 1B vs the output power Pₒ of the power generator 170. In FIG. 2, cycle T1 represents the period of one fluctuation (include up and down) of the wave; curve C1 represents the change in the output power Pₒ of the power generator 170; curve C2 represents the change in the internal pressure Pₐ of the accumulator 182 and reflects the ON/OFF state of the variable displacement hydraulic pump 181.

When the internal pressure Pₐ of the accumulator 182 reaches a pressure upper limit P_{a,up}, the variable displacement hydraulic pump 181 stops outputting the working fluid F1. Meanwhile, the value of the output displacement Q1 is 0, that is, not any fluid is outputted. Thus, the output power Pₒ of the power generator 170 can be controlled to be under an output power upper limit P_{o,up}. Since a buffer time is required for the variable displacement hydraulic pump 181 to change the schedule (the schedule change will result in repetitive switching of the ON/OFF state of the variable displacement hydraulic pump 181), oscillation will occur in the vicinity of the pressure upper limit P_{a,up} of FIG. 2 (such oscillation results from repetitive switching of the ON/OFF state of the variable displacement hydraulic pump 181). Such control method is referred as “passive control”.

Additionally, the output power upper limit P_{o,up} of FIG. 2 can be smaller than a maximum tolerable power Pₘₐₓ above which the power generator 170 will be broken, and the design of safety coefficient between the maximum tolerable power Pₘₐₓ and the output power upper limit P_{o,up} can reduce the probability of the power generator 170 being overloaded and damaged. In an embodiment, the maximum tolerable power Pₘₐₓ can be larger than the output power upper limit P_{o,up} by about 5%-10%, but the disclosure is not limited thereto. As indicated in FIG. 2, the set value of the pressure upper limit P_{a,up} depends on the output power upper limit P_{o,up}, In other words, the pressure upper limit P_{a,up} and the output power upper limit P_{o,up} are dependent on each other. For example, the larger the output power upper limit P_{o,up}, the larger the set value of the pressure upper limit P_{a,up}.

As indicated in FIG. 2, when the internal pressure Pₐ of the accumulator 182 is lower than the pressure upper limit P_{a,up}, the output power of the power generator 170 doss not reach the output power upper limit P_{o,up}. Therefore, the variable displacement hydraulic pump 181 can continuously output a working fluid F1 having the output displacement Q1 with a fixed volume, such that the internal pressure Pₐ of the accumulator 182 can be continuously increased and more power can be generated. It should be noted that, in the present embodiment, through the control mechanism of FIG. 1B, the variable displacement hydraulic pump 181 can switch the ON/OFF state of the variable displacement hydraulic pump 181 according to the internal pressure Pₐ of the accumulator 182 to control the output displacement Q1 of the working fluid F1 outputted by the variable displacement hydraulic pump 181. Furthermore, when the internal pressure Pₐ of the accumulator 182 reaches the pressure upper limit P_{a,up}, the variable displacement hydraulic pump 181 is turned off. Meanwhile, the variable displacement hydraulic pump 181 does not output any working fluid F1, and the value of the output displacement Q1 is 0. When the internal pressure Pₐ of the accumulator 182 does not reach the pressure upper limit P_{a,up}, the variable displacement hydraulic pump 181 is turned on and continuously discharges the working fluid F1 having the output displacement Q1 with a fixed volume.

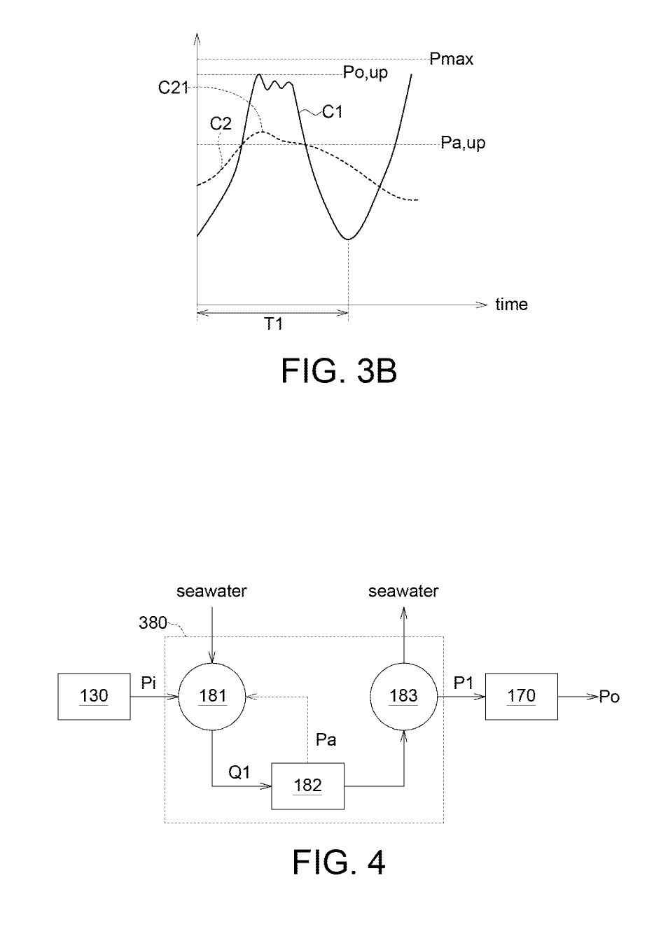

Refer to FIGS. 3A and 3B. FIG. 3A is a function block diagram of a wave energy isolation device 280 according to another embodiment of the disclosure. FIG. 3B is a relationship diagram of the internal pressure Pₐ of the wave energy isolation device 280 of FIG. 3A vs the output power Pₒ of the power generator 170.

The wave energy isolation device 280 includes a variable displacement hydraulic pump 181, an accumulator 182, a fixed displacement hydraulic motor 183, a fluid container 184 and a pressure controller 285. The pressure controller 285 can set the value of the output displacement Q1 of the working fluid F1 outputted by the variable displacement hydraulic pump 181 according to the internal pressure Pₐ of the accumulator 182. Such control is referred as “active control”.

In an embodiment, the pressure controller 285 may include a proportional-integral-derivative (PID) controller. By using the automatic feedback technique, the PID controller precisely controls the output displacement Q1 to a displacement upper limit Qᵤₚ, and therefore resolves the oscillation phenomenon of passive control as indicated in FIG. 2. As indicated in the curve C2 of FIG. 3B, although the internal pressure Pₐ still has an overshooting C21 (the overshooting reflects the actuation mode of the variable displacement hydraulic pump 181), the oscillation phenomenon of passive control is greatly resolved. Thus, with the design of the pressure controller 285, repetitive switching of the ON/OFF state of the variable displacement hydraulic pump 181 is avoided, and the accelerated damage of the variable displacement hydraulic pump 181 due to repetitive switching is also avoided.

The pressure controller 285 sets the value of the output displacement Q1 of the variable displacement hydraulic pump 181 according to the internal pressure Pₐ of the accumulator 182. In an embodiment, the pressure controller 285 determines the value of the output displacement Q1 according to the historical data of the internal pressure Pₐ of the accumulator 182. In other words, the value of the output displacement Q1 depends on the historical data of the internal pressure. For example, when the historical data of the internal pressure Pₐ oscillate around an average displacement, the pressure controller 285 can set the value of the output displacement Q1 to be corresponding to the average displacement or set the value of the output displacement Q1 to the minimum of multiple historical values of internal pressure. In another embodiment, when the expected wave energy will continuously remain at a large wave energy over a period of time (for example, a typhoon or a cyclone is coming), the pressure controller 285 controls the value of the output displacement Q1 of the variable displacement hydraulic pump 181 at the displacement upper limit Qᵤₚ, wherein the displacement upper limit Qᵤₚ corresponds to the upper limit of the internal pressure Pₐ of FIG. 3B, that is, the pressure upper limit P_{a,up}. In other words, the displacement upper limit Qᵤₚ is a set value of displacement allowing the output power Pₒ of the power generator 170 to be close to but not larger than the output power upper limit P_{o,up}. It should be noted that, in the present embodiment, with the control mechanism of FIG. 3A, the variable displacement hydraulic pump 181 can control the output displacement Q1 of the working fluid F1 outputted when the variable displacement hydraulic pump 181 is turned on according to the value of the output displacement Q1 set by the pressure controller 285. Furthermore, when the value of the output displacement Q1 set by the pressure controller 285 is the displacement upper limit Qᵤₚ, the variable displacement hydraulic pump 181 when turned on will use the displacement upper limit Qᵤₚ as the output displacement Q1 of the working fluid F1 and output the working fluid F1 according to the displacement upper limit Qᵤₚ. When the value of the output displacement Q1 set by the pressure controller 285 corresponds to the average displacement of the historical data of the internal pressure Pₐ, the variable displacement hydraulic pump 181 when turned on will use the average displacement of the historical data of the internal pressure Pₐ as the output displacement Q1 of the working fluid F1 and output the working fluid F1 according to the average displacement.

Referring to FIG. 4, a function block diagram of a wave energy isolation device 380 according to another embodiment of the disclosure is shown. The wave energy isolation device 380 includes a variable displacement hydraulic pump 181, an accumulator 182 and a fixed displacement hydraulic motor 183. It should be noted that, in the present embodiment, the wave energy isolation device 380 dispenses with the fluid container 184, and the working fluid F1 can be realized by sea water.

Since the working fluid F1 is sea water, the sea becomes the fluid container of the wave energy isolation device 380. As indicated in FIG. 4, sea water is sucked to the wave energy isolation device 380 and pressurized by the variable displacement hydraulic pump 181, and then is outputted to the fixed displacement hydraulic motor 183 through the accumulator 182. The pressurized sea water drives the fixed displacement hydraulic motor 183 to operate and the fixed displacement hydraulic motor 183 provide an output shaft power P1 to the power generator 170. The sea water discharged from the fixed displacement hydraulic motor 183 reflows to the sea.

In the above embodiments, the variable displacement hydraulic pump 181 controls the output displacement Q1 of sea water according to the internal pressure Pₐ of the accumulator 182, but the disclosure is not limited thereto. In another embodiment, the variable displacement hydraulic pump 181 controls the value of the output displacement Q1 of the working fluid F1 according to the rotation speed of the power generator 170 (the rotation speed can be expressed as rotations per minute (rpm)).

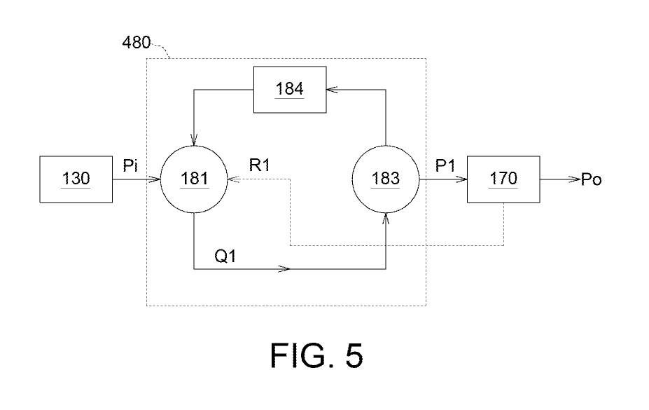

Referring to FIG. 5, a function block diagram of a wave energy isolation device 480 according to another embodiment of the disclosure is shown. The wave energy isolation device 480 includes a variable displacement hydraulic pump 181, a fixed displacement hydraulic motor 183 and a fluid container 184. The wave energy isolation device 480 has a structure similar to that of the wave energy isolation device 180. It should be noted that, in the present embodiment, the wave energy isolation device 480 dispenses with the accumulator 182.

As indicated in FIG. 5, the rotation speed R1 of the power generator 170 can be fed back to the variable displacement hydraulic pump 181 which determines the output displacement Q1 of the working fluid F1 according to the rotation speed R1. The rotation speed R1 of the output shaft (not illustrated) of the power generator 170 is positively proportional to the pressure of the working fluid F1 (that is, the internal pressure Pₐ of the accumulator 182). Like the control method of the internal pressure Pₐ, in an embodiment, when the rotation speed R1 reaches a rotation speed upper limit, the value of the output displacement Q1 of the working fluid F1 provided by the variable displacement hydraulic pump 181 is 0. In another embodiment, when the rotation speed R1 is lower than the rotation speed upper limit, the variable displacement hydraulic pump 181 continues to provide the working fluid F1 having the output displacement Q1.

In another embodiment, the rotation speed R1 of the output shaft (not illustrated) fed back to the variable displacement hydraulic pump 181 can also be the rotation speed of the fixed displacement hydraulic motor 183. The rotation speed of the fixed displacement hydraulic motor 183 is positively proportional to the pressure of the working fluid F1 (that is, the internal pressure Pₐ of the accumulator 182).

To summarize, the wave energy isolation device disclosed in above embodiments of the disclosure includes a variable displacement hydraulic pump and a fixed displacement hydraulic motor. The variable displacement hydraulic pump outputs a working fluid to the fixed displacement hydraulic motor. The variable displacement hydraulic pump changes an output displacement of the working fluid according to a control parameter. The control parameter is such as the internal pressure of the accumulator, the rotation speed of the output shaft of the power generator or the rotation speed of the output shaft of the fixed displacement hydraulic motor. In an embodiment, when the control parameter reaches an upper limit, the value of the output displacement of the working fluid provided by the variable displacement hydraulic pump is 0. Thus, the output shaft power provided to the power generator by the fixed displacement hydraulic motor is restricted to avoid the power generator being overloaded and damaged.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A wave energy isolation device, comprising:
a fixed displacement hydraulic motor; and
a variable displacement hydraulic pump configured for outputting a working fluid to the fixed displacement hydraulic motor, wherein the variable displacement hydraulic pump changes an output displacement of the working fluid according to a control parameter.

2. The wave energy isolation device according to claim 1, further comprising:
an accumulator;
wherein the working fluid is outputted to the fixed displacement hydraulic motor from the variable displacement hydraulic pump through the accumulator, and the control parameter is an internal pressure of the accumulator.

3. The wave energy isolation device according to claim 2, wherein when the internal pressure of the accumulator reaches a pressure upper limit, a value of the output displacement of the working fluid provided by the variable displacement hydraulic pump is 0.

4. The wave energy isolation device according to claim 2, further comprising:
a pressure controller configured for setting a value of the output displacement of the variable displacement hydraulic pump according to an internal pressure of the accumulator.

5. The wave energy isolation device according to claim 1, wherein the control parameter is a rotation speed of a power generator, and the fixed displacement hydraulic motor is connected to the power generator and provides an output shaft power to the power generator.

6. The wave energy isolation device according to claim 1, wherein the control parameter is a rotation speed of the fixed displacement hydraulic motor.

7. The wave energy isolation device according to claim 1, further comprising:
a fluid container configure for receiving the working fluid discharged from the fixed displacement hydraulic motor and providing the working fluid to the variable displacement hydraulic pump.

8. A wave energy conversion equipment, comprising:
a wave energy isolation device, comprising:
a fixed displacement hydraulic motor; and
a variable displacement hydraulic pump configured for outputting a working fluid to the fixed displacement hydraulic motor, wherein the variable displacement hydraulic pump changes an output displacement of the working fluid according to a control parameter;
a winch connected to the variable displacement hydraulic pump and configured for providing an input shaft power to drive the variable displacement hydraulic pump; and
a power generator connected to the fixed displacement hydraulic motor;
wherein the fixed displacement hydraulic motor is driven by the working fluid to provide an output shaft power to the power generator.

9. The wave energy conversion equipment according to claim 8, wherein the wave energy isolation device further comprises:
an accumulator;
wherein the working fluid is outputted to the fixed displacement hydraulic motor from the variable displacement hydraulic pump through the accumulator, and the control parameter is an internal pressure of the accumulator.

10. The wave energy conversion equipment according to claim 9, wherein when the internal pressure of the accumulator reaches a pressure upper limit, a value of the output displacement of the working fluid provided by the variable displacement hydraulic pump is 0.

11. The wave energy conversion equipment according to claim 9, wherein the wave energy isolation device further comprises:
a pressure controller configured for setting a value of the output displacement of the variable displacement hydraulic pump according to the internal pressure of the accumulator.

12. The wave energy conversion equipment according to claim 8, wherein the control parameter is a rotation speed of the power generator.

13. The wave energy conversion equipment according to claim 8, wherein the control parameter is a rotation speed of the fixed displacement hydraulic motor.

14. The wave energy conversion equipment according to claim 8, wherein the wave energy isolation device further comprises:
a fluid container configured for receiving the working fluid discharged from the fixed displacement hydraulic motor and providing the working fluid to the variable displacement hydraulic pump.
